(19) United States
(12) Patent Application Publication
(10) Pub. No.: US 2010/0202369 A1
(43) Pub. Date: Aug. 12, 2010

(54) Apparatus, Method and Computer Program Product Providing Harq-Aware Packet Scheduler

(75) Inventors: Klaus Ingemann Pedersen, Aalborg (DK); Akhilesh Pokhariyal, Aalborg East (DK)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/439,521

(22) PCT Filed: Aug. 28, 2007
(86) PCT No.: PCT/IB2007/002478

§ 371 Date: Apr. 20, 2010

Related U.S. Application Data
(60) Provisional application No. 60/840,873, filed on Aug. 28, 2006.

(51) Int. Cl. H04W 72/12

(52) U.S. Cl. 370/329

(57) ABSTRACT

Methods and apparatus operative in a wireless communications system divide a communications resource available for performing information transmission and retransmission operations into a plurality of communication resource units. Channel quality information is used to rank each of the communication resource units in terms of channel quality. The communication resource units are divided into a first group having better channel quality and a second group having worse channel quality. The first group of communication resource units having better channel quality is used to transmit new information to a first group of receiving communication devices. The second group of communication resource units having worse channel quality is used to retransmit information to a second group of receiving communication devices. In such a manner simultaneous scheduling of information transmission and retransmission may be accommodated in a 3GPP LTE OFDM based wireless communications system.

### RELATED APPLICATIONS

This application was originally filed as PCT Application No. PCT/ib2007/002478 filed Aug. 28, 2007, which claims the priority of U.S. Patent Application No. 60/840,873 filed Aug. 28, 2006.

### TECHNICAL FIELD

The exemplary and non-limiting embodiments of this invention relate generally to wireless communication systems, methods, devices and computer program products and, more specifically, relate to techniques for use during the scheduling of transmissions to multiple receivers.

### BACKGROUND

The following abbreviations are herewith defined:

3GPP third generation partnership project

ARQ automatic repeat request

BLER block error ratio

C/I carrier to interference ratio

CQI channel quality indicator

DL downlink

HARQ hybrid ARQ

LTE long term evolution

Node B base station

eNB EUTRAN Node B

OFDMA orthogonal frequency division multiple access

PRB physical resource block

PS Packet Scheduler

TTI transmission timing interval

UL uplink

UE user equipment

UTRAN universal terrestrial radio access network

EUTRAN evolved UTRAN

aGW access gateway

A proposed communication system known as evolved UTRAN (E-UTRAN, also referred to as UTRAN-LTE) is at present a study item within the 3GPP. The current working assumption is that the access technique will be OFDMA for the DL and SC-FDMA for the UL, which are both based on OFDM technique and can be expected to provide an opportunity to perform link adaptation and user multiplexing in the frequency domain.

Several publications have reported the results of studies related to frequency domain packet scheduling for OFDM-based systems such as UTRAN-LTE. However, these publications do not explicitly discuss how to accommodate the simultaneous scheduling of new data and pending HARQ retransmissions.

As is described in section 9.1.2.5 of 3GPP TR 25.814 V7.0.0 (2006-06), Technical Report, 3rd Generation Partnership Project; Technical Specification Group Radio Access Network; Physical layer aspects for evolved Universal Terrestrial Radio Access (UTRA) (Release 7), in general HARQ can be classified as being synchronous or asynchronous.

Synchronous HARQ implies that (re)transmissions for a certain HARQ process are restricted to occur at known time instants. No explicit signaling of the HARQ process number is required as the process number can be derived from, e.g., the subframe number.

Asynchronous HARQ implies that (re)transmission for a certain HARQ process may occur at any time. Explicit signaling of the HARQ process number is therefore required.

In principle, synchronous operation with an arbitrary number of simultaneous active processes at a time instant could be envisioned. In this case, additional signaling may be required. Asynchronous operation already supports an arbitrary number of simultaneous active processes at a time instant. Furthermore, note that, in a synchronous scheme the transmitter may choose not to utilize all possible retransmission instants, e.g., to support pre-emption. This may require additional signaling.

The various forms of HARQ are further classified as adaptive or non-adaptive in terms of transmission attributes, e.g., the resource unit (RU) allocation, modulation and transport block size, and the duration of the retransmission. Control channel requirements can be different for each case.

Adaptive HARQ implies that the transmitter may change some or all of the transmission attributes used in each retransmission, as compared to the initial transmissions (e.g. due to changes in the radio conditions). Hence, the associated control information needs to be transmitted with the retransmission. The changes considered are: modulation, resource unit allocation and duration of transmission.

Non-adaptive HARQ implies that changes, if any, in the transmission attributes for the retransmissions are known to both the transmitter and receiver at the time of the initial transmission. Hence, associated control information need not be transmitted for the retransmission.

With those definitions, the HS-DSCH in WCDMA uses an adaptive, asynchronous HARQ scheme, while the E-DCH in WCDMA uses a synchronous, non-adaptive HARQ scheme.

The capability to adaptively change the packet format (i.e., adaptive IR) and the transmission timing (i.e., asynchronous IR) yields an adaptive, asynchronous IR based HARQ operation. Such a scheme has the potential of optimally allocating the retransmission resources in a time varying channel. For each HARQ retransmission, control information about the packet format needs to be transmitted together with the data sub-packet.

Synchronous HARQ transmission entails operating the system on the basis of a predefined sequence of retransmission packet format and timing.

In view of the foregoing those skilled in the art seek methods and apparatus that accommodate the simultaneous scheduling of new data and pending HARQ retransmissions.

### SUMMARY OF THE INVENTION

A first embodiment of the invention is a method comprising: dividing a communication resource in use in a communications system into a plurality of communication resource units; dividing the communication resource units into a first group of communication resource units and a second group of communication resource units; using the first group of communication resource units to transmit information to a first group of communication devices operative in the communication system; and using the second group of communication resource units to retransmit information to a second group of communication devices operative in the communication system.

A second embodiment of the invention is a method comprising: dividing a communication resource in use in a communication system into a plurality of communication resource units, the communication resource units available for use by a transmitting communication device to perform information transmission and retransmission operations; using channel quality information associated with each of the communication resource units to rank the communication resource units in terms of channel quality; dividing the communication resource units into a first group having better channel quality and a second group having worse channel quality; dividing a plurality of receiving communication devices operative in the communication system into two groups in dependence on which receiving communication devices of the plurality have requested information to be retransmitted to them by the transmitting communication device, wherein receiving communication devices that have not requested information retransmission comprise a first group and receiving communication devices that have requested information retransmission comprise a second group; using the first group of communication resource units having better channel quality to transmit new information to the first group of receiving communication devices; and using the second group of communication resource units to retransmit information to the second group of receiving communication devices.

A third embodiment of the invention is a computer program product comprising a computer readable memory medium tangibly embodying a computer program, the computer program configured to be executed by processing apparatus of a transmitting communication device operating in a wireless communication system, wherein when executed the computer program is configured to cause the transmitting communication device to divide a communication resource in use in a communication system into a plurality of communication resource units; to divide the communication resource units into a first group of communication resource units and a second group of communication resource units; to use the first group of communication resource units to transmit information to a first group of communication devices operative in the communication system; and to use the second group of communication resource units to retransmit information to a second group of communication devices operative in the communication system.

A fourth embodiment of the invention is a communications device comprising: a transceiver configured for bi-directional communication in a wireless communications system; and a control apparatus configured to divide a communication resource in use in a communication system into a plurality of communication resource units; to divide the communication resource units into a first group of communication resource units and a second group of communication resource units; to use the first group of communication resource units to transmit information to a first group of communication devices operative in the communication system; and to use the second group of communication resource units to retransmit a second group of communication devices operative in the communication system.

A fifth embodiment of the invention is a communications device comprising: transceiver means for performing bi-directional communication in a wireless communications system; a channel quality means for receiving channel quality information; a retransmission request means for receiving retransmission requests from receiving communication devices operative in the wireless communications system; and a scheduler means for dividing a communication resource in use in the communications system into a plurality of communication resource units; for ranking the communication resource units in terms of channel quality information received by the channel quality means; for dividing the communication resource units into a first group of communication resource unit and a second group of communication resource units in dependence on the channel quality ranking; for dividing a plurality of receiving communication devices operative in the communication system into two groups in dependence on which receiving communication devices of the plurality have requested information to be retransmitted to them by the communication device, wherein receiving communication devices that have not requested information retransmission comprise a first group and receiving communication devices that have requested information retransmission comprise a second group; for using the first group of communication resource units to transmit new information to the first group of receiving communication devices; and for using the second group of communication resource units to retransmit information to the second group of receiving communication devices.

In conclusion, the foregoing summary of the embodiments of the present invention is exemplary and non-limiting. For example, one of ordinary skill in the art will understand that one or more aspects or steps from one embodiment can be combined with one or more aspects or steps from another alternate embodiment to create a new embodiment within the scope of the present invention.

### BRIEF DESCRIPTION OF THE DRAWINGS

In the attached Drawing Figures:

FIG. 1 shows a simplified block diagram of various electronic devices that are suitable for use in practicing the exemplary embodiments of the invention;

FIG. 2 illustrates a frequency domain scheduling method in accordance with the exemplary embodiments of the invention;

FIG. 3 is a flow chart depicting a method operating in accordance with the invention; and

FIG. 4 is a flow chart depicting another method operating in accordance with the invention.

### DETAILED DESCRIPTION

In accordance with the exemplary embodiments of this invention there is provided a technique to extend and enhance a frequency domain packet scheduler to also accommodate scheduling of HARQ retransmissions, given constraints that exist for scheduling of such retransmissions.

Further in accordance with the exemplary embodiments of this invention there is provided a technique to perform frequency domain packet scheduling for OFDM systems, including the scheduling of both new data and pending HARQ retransmissions. In order to describe the exemplary embodiments the 3GPP LTE system is used as a non-limiting example of one OFDM system. Attention is focused on the downlink with localized transmission, where the full bandwidth is divided into a set of physical resource blocks (PRBs), each containing of 25 neighboring sub-carriers. Thus, in a 10 MHz bandwidth, there exist 24 PRBs. User multiplexing in the frequency domain is assumed to be controlled by a packet scheduler, with a granularity of a maximum one user per PRB. Users are allowed to be multiplexed on several PRBs. In the 3GPP LTE system the packet scheduler is resident at the eNB, although this is not a limitation upon the practice of the exemplary embodiments of this invention.

Further in accordance with the exemplary embodiments of this invention there is provided a general frame-work for the frequency domain packet scheduler to handle cases where a mixture of new data and pending HARQ retransmissions are multiplexed in the same TTI. This frame-work supports application of various scheduling algorithms, and may benefit from using radio channel aware frequency domain packet scheduling to achieve a so-called frequency domain scheduling gain.

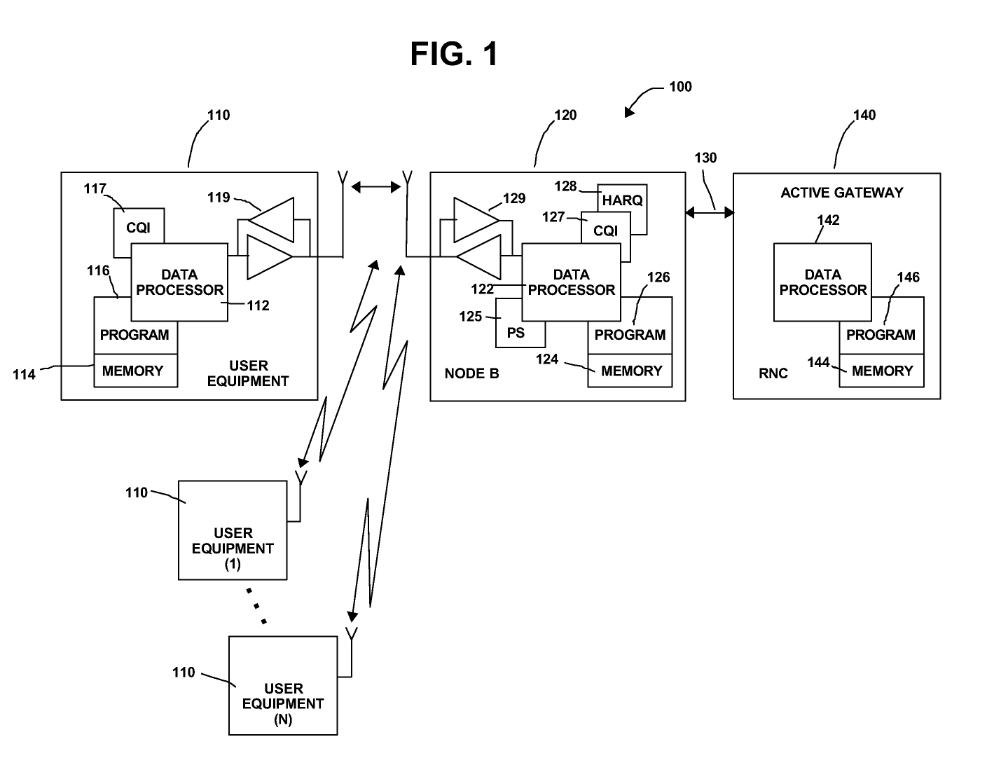

Reference is made to FIG. 1 for illustrating a simplified block diagram of various electronic devices that are suitable for use in practicing the exemplary embodiments of this invention. In FIG. 1 a wireless network 100 is adapted for communication with at least one UE 110 via a Node B (base station), which for LTE is referred to as an eNB 120. The network 100 may include a network element (NE) 140, such as an aGW. The UE 110 includes a data processor (DP) 112, a memory (MEM) 114 that stores a program (PROG) 116, and a suitable radio frequency (RF) transceiver 119 for bidirectional wireless communications with the eNB 120, which also includes a DP 122, a MEM 124 that stores a PROG 126, and a suitable RF transceiver 129. The eNB 120 is coupled via a data path 130 to the NE 140 that also includes a DP 142 and a MEM 144 storing an associated PROG 146.

Note that in FIG. 1 there may typically be a plurality of UEs 100 present in the cell serviced by the eNB 120, labeled for convenience as User 1, User 2, . . . , User N.

Also shown in FIG. 1 there is a frequency domain PS 125, a CQI unit 127 and a HARQ function 128 located at the eNB 120. These three units cooperate with one another during the operation of the eNB 120, as will be discussed below. The UE 110 may include a CQI unit 117 for reporting CQI information to the eNB 120.

For the embodiment shown in FIG. 1 at least the PROG 126 is assumed to include program instructions that, when executed by the associated DP, enable the electronic device to operate in accordance with the exemplary embodiments of this invention, as will be discussed below in greater detail.

In general, the various embodiments of the UE 110 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the DP 122, or by hardware, or by a combination of software and hardware.

The MEMs 114, 124 and 144 may be of any type suitable to the local technical environment and may be implemented using any suitable data storage technology, such as semiconductor-based memory devices, magnetic memory devices and systems, optical memory devices and systems, fixed memory and removable memory. The DPs 112, 122 and 142 may be of any type suitable to the local technical environment, and may include one or more of general purpose computers, special purpose computers, microprocessors, digital signal processors (DSPs) and processors based on a multi-core processor architecture, as non-limiting examples.

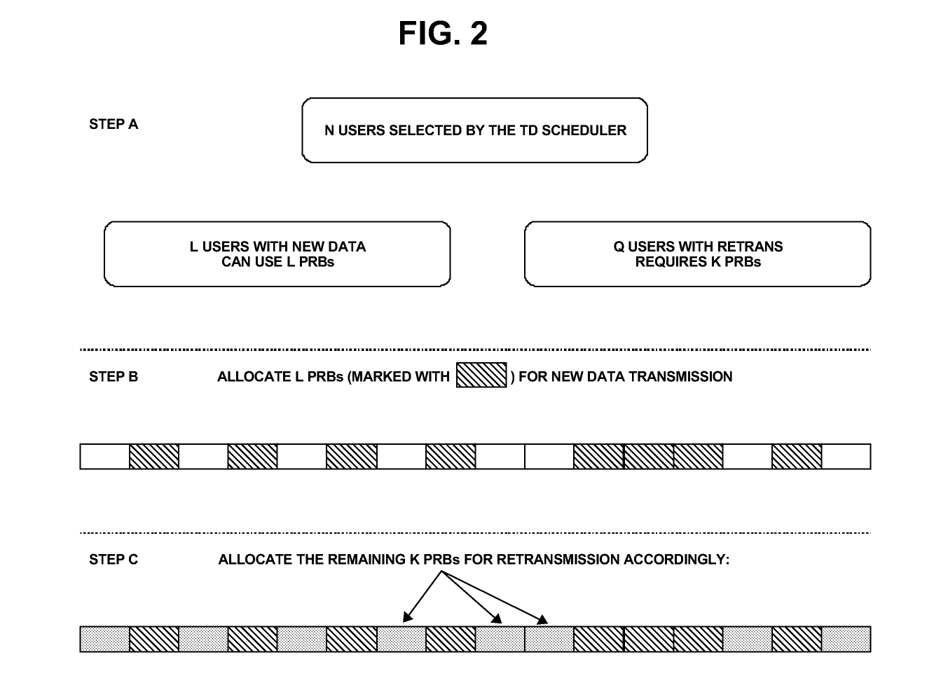

The frequency domain PS 125 described herein operates under the assumption that a CQI is available for each user, and for each PRB. Referring now also to FIG. 2, given the set of N users to be frequency multiplexed, a first step (Step A) determines if one or more of the Users 1 through N have pending HARQ retransmissions. This information can be made available to the PS 125 from the HARQ unit 128. If one or more of the Users 1 through N have pending HARQ retransmissions, then the pending HARQ retransmissions should be transmitted before transmitting new data for these same users (at least in order to reduce retransmission delays). It should be noted that retransmissions are preferably transmitted on the same number of PRBs as the original transmission, and also on the same PRBs if non-adaptive HARQ is in use. However, in the ensuing discussion the use of adaptive HARQ is assumed, and the PS 125 has the freedom to decide which PRBs to use for HARQ retransmissions (which is the current assumption for DL LTE in 3GPP).

Denoting the number of available PRBs with a parameter M (for example, M=24 for a 10 MHz bandwidth), and assuming that K PRBs are required to schedule the pending HARQ retransmissions for Q of the N selected users (Q≦N), if K≦M, then all of the pending HARQ retransmissions can be scheduled, otherwise only a sub-set of the pending HARQ retransmissions can be transmitted during the next TTI. Assuming K≦M, there are L=(M−K) PRBs available for transmission of new data for those users without pending HARQ retransmissions.

If one assumes a reasonable initial BLER target of no more than about 10%-20% for first transmissions, it is likely that the HARQ retransmission will be successfully decoded even though the retransmission is scheduled on PRB(s) with up to about 2-3 dB lower SINR than the original retransmission. This is due at least in part to the soft combining gain from using incremental redundancy or Chase Combining.

Reference with regard to Chase Combining can be made to: D. Chase, “Code combining-A maximum-likelihood decoding approach for combining an arbitrary number of packets,” IEEE Trans. on Communications, Vol. 33, no. 5, pp. 385-393, 1985.

Reference with regard to a discussion of incremental redundancy may be made to F. Frederiksen, T. E. Kolding, “Performance and modeling of WCDMA/HSDPA transmission/H-ARQ schemes”, IEEE Proc. VTC, pp. 472-476, September 2002.

Assuming the reasonable initial BLER target of no more than about 10%-20% for first transmissions, the PS 125 allocates L PRBs for new data transmission (Step B), and allocates the remaining K PRBs for retransmissions (Step C). That is, the PS 125 first schedules the N-Q users with new data on the best L PRBs before allocating PRBs for retransmissions. In this context, “best” PRBs refers to those PRBs where users are experiencing relatively good radio channel quality (i.e., those users reporting a relatively high CQI). This strategy is preferred as it gives more degrees of freedom for scheduling new data. If instead the PS 125 attempts to first schedule HARQ retransmissions on the good PRBs, it may potentially use an excessive amount of energy on the good PRBs, while at the same time limiting the flexibility for transmission of new data.

The exemplary embodiments of this invention thus provide for the division of the activity of the frequency domain scheduler (assumed for this description to comprise a part of the PS 125) into the three steps depicted in FIG. 2. For the allocation of users on PRBs using Steps B and C, any suitable algorithm may be employed such as, but not limited to, the well-known proportional fair scheduler, the maximum C/I and the round robin approaches.

As a non-limiting example, the use of proportional fair scheduling (in the context of transmit diversity) is described by Lars T. Berger, Troels E. Kolding, Juan Ramiro-Moreno, Pablo Ameigeiras, Laurent Schumacher and Preben E. Mogensen, “Interaction of Transmit Diversity and Proportional Fair Scheduling”, Vehicular Technology Conference, 2003. VTC 2003-Spring 22-25 Apr. 2003, Volume: 4, pgs. 2423-2427.

The following paper contains a discussion of packet schedulers: A. Jalali, R. Padovani, R. Pankaj, “Data Throughput of CDMA-HDR a High Efficiency-High Data Rate Personal Communication Wireless System”, IEEE Proc. VTC, pp. 1854-1858, May 2000.

In addition, the following book is a good reference to both IR and packet scheduling issues; H. Holma, A. Toskala (editors), “HSDPA/HSUPA for UMTS”, Wiley, April 2006.

As was noted, the downlink frequency domain PS 125 for an OFDM system is implemented in the base station (referred to as the eNode-B or eNB 12 for LTE). However, the exemplary embodiments of this invention can be employed with a frequency domain packet scheduler that is embodied elsewhere, such as a centralized PS that resides at a higher level than the eNB(s) 120.

Based on the foregoing it should be apparent that the exemplary embodiments of this invention provide a method, apparatus and computer program product(s) to provide flexible joint scheduling of new data and pending HARQ retransmissions, wherein HARQ retransmission delays are minimized while striving to maximize the data rate for new transmissions. This is achieved by giving new transmissions a higher priority by first assigning PRBs for the new transmissions.

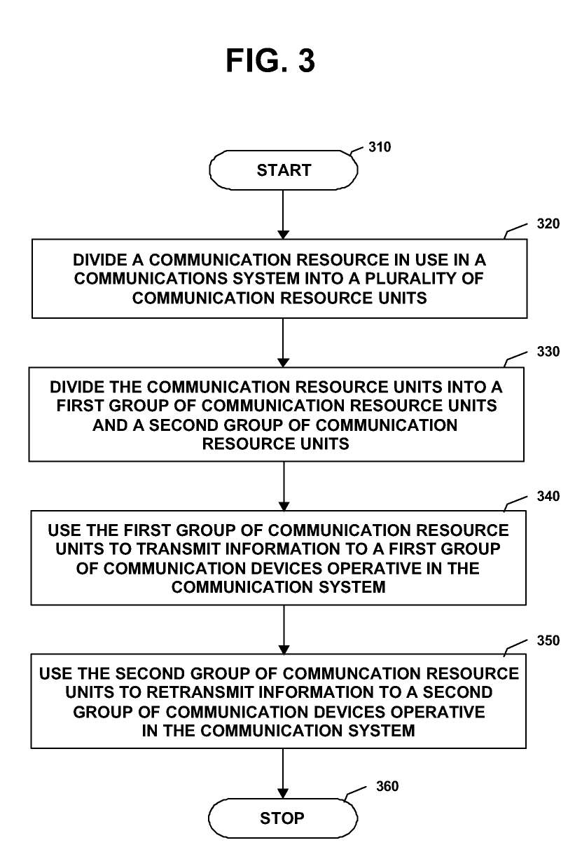

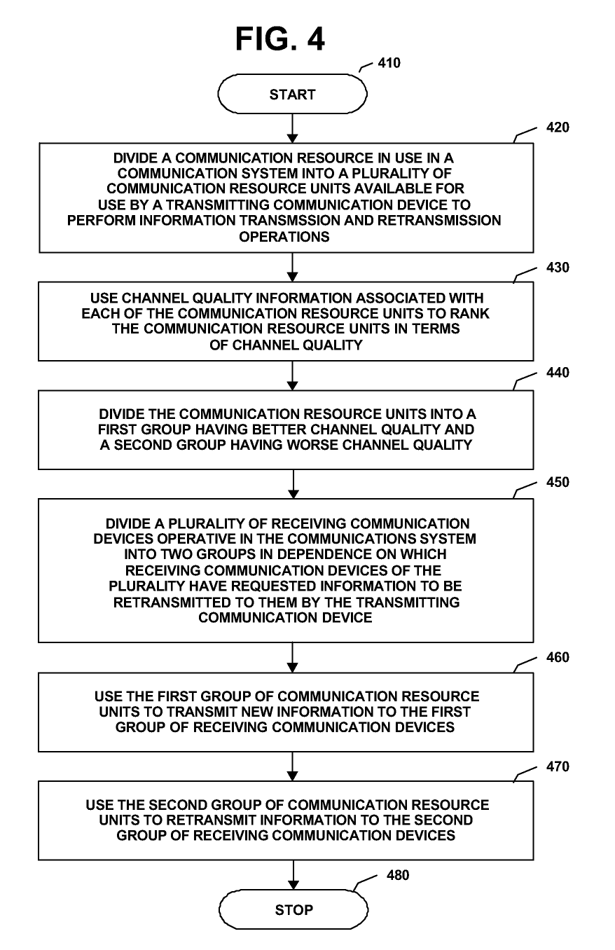

Methods operating in accordance with the invention are summarized in FIGS. 3-4. The methods depicted can be performed by an eNB 120 operative in an OFDM-based wireless communication system 100 like that depicted in FIG. 1. The method depicted in FIG. 3 starts at 310. Then, at 320, the data processor 122 of eNB 120 executes program instructions 126 that cause eNB 120 to divide a communication resource in use in the communications system into a plurality of communication resource units. Next, at 330, the data processor 122 of eNB 120 executes program instructions that cause eNB 120 to divide the communication resource units into a first group of communication resource units and a second group of communication resource units. Then, at 340, the data processor 122 of eNB 120 executes program instructions that cause packet scheduler 125 to use the first group of communication resource units to transmit information to a first group of communication devices operative in the communications system. Next, at 350, the data processor 122 of eNB 120 executes program instructions that cause PS 125 to use the second group of communication resource units to retransmit information to a second group of communication devices operative in the communication system. The method then stops at 360.

In a variant of the method depicted in FIG. 3 the communications system is an OFDM-based wireless communications system. In another variant of the method depicted in FIG. 3 the communication resource units comprise physical resource blocks available to perform information transmission and retransmission operations in the OFDM-based wireless communications system. In a further variant of the method depicted in FIG. 3 the OFDM-based wireless communications system is a 3GPP LTE wireless communications system.

In yet another variant of the method depicted in FIG. 3, using the second group of communication resource units to retransmit information to a second group of communication devices operative in the communications system comprise HARQ retransmission operations. The HARQ retransmission operations may comprise adaptive or non-adaptive retransmission operations.

In a still further variant of the method depicted in FIG. 3, the data processor 122 of eNB 120 executes program instructions that cause the CQI unit 127 of eNB 120 to receive channel quality information associated with each of the communication resource units.

In another variant of the method depicted in FIG. 3, the data processor 122 of eNB 120 executes program instructions that cause the packet scheduler 125 to cooperate with CQI unit 127 to rank the communication resource units in terms of channel quality; to select communication resource units having better channel quality and to assign them to the first group of communication resource units; and to assign communication resource units not assigned to the first group of communication resource units to the second group of communication resource units, the second group of communication resource units having worse channel quality.

In a further variant of the method depicted in FIG. 3, the data processor 122 of eNB 120 executes program instructions that cause the packet scheduler 125 to divide a plurality of communication devices operative in the communication system into the first group of communication devices and the second group of communication devices in dependence on which communication devices have requested information retransmission, where communication devices that have not requested information retransmission are assigned to the first group of communication devices and the communication device that have requested information retransmission are assigned to the second group of communication devices.

Another method operating in accordance with the invention is depicted in FIG. 4. The method depicted in FIG. 4 starts at 410. Next, at 420, the data processor 122 of eNB 120 executes program instructions that cause eNB 120 to divide a communication resource in use in a communication system into a plurality of communication resource units available for use by the eNB 120 to perform information transmission and retransmission operations. Then, at 430, the data processor of eNB 120 executes program instructions that cause CQI unit 127 to use channel quality information associated with each of the communication resource units to rank the communication resource units in terms of channel quality. Next, at 440, the data processor 122 of the eNB 120 executes program instructions that cause the packet scheduler 125 to cooperate with the CQI unit 127 to divide the communication resource units into a first group having better channel quality and a second group having worse channel quality. Then, at 450, the data processor 122 of eNB 120 executes program instructions that cause the HARQ unit 128 to divide a plurality of receiving communication devices operative in the communications system into two groups in dependence on which receiving communication devices of the plurality have requested information to be retransmitted to them by eNB 120. Next, at 460, the data processor 122 of eNB 120 executes program instructions that cause packet scheduler 125 to use the first group of communication resource units to transmit new information to the first group of receiving communication devices. Then, at 470, the data processor 122 of eNB 120 executes program instructions that cause packet scheduler 125 to use the second group of communication resource units to retransmit information to the second group of receiving communication devices. The method stops at 480.

In a variant of the method depicted in FIG. 4 the communications system is an OFDM-based wireless communication system. In another variant of the method depicted in FIG. 4 the communication resource units comprise physical resource blocks available to perform information transmission and retransmission operations in the OFDM-based wireless communications system. In a further variant of the method depicted in FIG. 4 the OFDM-based wireless communications system is a 3GPP LTE wireless communications system.

In yet another variant of the method depicted in FIG. 4, using the second group of communication resource units to retransmit information to the second group of receiving communication devices comprise HARQ operations. The HARQ operations may comprise adaptive or non-adaptive HARQ operations.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or with some other pictoral representation, it should be understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the invention may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. For example, the described number of PRBs, as well as the various types of scheduling algorithms, are exemplary, and should not be read as limitations upon the practice of the exemplary embodiments of this invention. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
dividing a communication resource in use in a communications system into a plurality of communication resource units;
dividing the communication resource units into a first group of communication resource units and a second group of communication resource units;
using the first group of communication resource units to transmit information to a first group of communication devices operative in the communication system; and
using the second group of communication resource units to retransmit information to a second group of communication devices operative in the communication system, wherein using the second group of communication resource units to retransmit information comprise at least one of adaptive and non-adaptive HARQ retransmission operations

2. (canceled)

3. A method as in claim 2 wherein the communication resource units comprise physical resource blocks available to perform information transmission and retransmission operations in the OFDM-based wireless communications system.

4-7. (canceled)

8. A method as in claim 1 further comprising:
receiving channel quality information associated with each of the communication resource units.

9. A method as in claim 8 wherein dividing the communication resource units into a first group of communication resource units and a second group of communication resource units further comprises:
ranking the communication resource units in terms of channel quality using the channel quality information;
selecting communication resource units having better channel quality and assigning them to the first group of communication resource units; and
assigning communication resource units not assigned to the first group of communication resource units to the second group of communication resource units, the second group of communication resource units having worse channel quality.

10. A method as in claim 9 further comprising:
dividing a plurality of communication devices operative in the communication system into the first group of communication devices and the second group of communication devices in dependence on which communication devices have requested information retransmission, where communication devices that have not requested information retransmission are assigned to the first group of communication devices and the communication devices that have requested information retransmission are assigned to the second group of communication devices.

11. A method as in claim 10 wherein the first group of communication resource units having better channel quality are used to transmit information to the first group of communication devices and the second group of communication resource units having worse channel quality are used to retransmit information to the second group of communication devices.

12. An apparatus comprising:
A scheduler configured to divide a communication resource in use in a communication system into a plurality of communication resource units, to divide the communication resource units into a first group of communication resource units and a second group of communication resource units;
to use the first group of communication resource units to transmit information to a first group of communication devices operative in the communication system; and to use the second group of communication resource units to retransmit information to a second group of communication devices operative in the communication system, wherein to use the second group of communication resource units to retransmit information comprise at least one of adaptive and non-adaptive HARQ retransmission operations.

13. (canceled)

14. A apparatus as in claim 12 wherein the communication resource units comprise physical resource blocks available to perform information transmission and retransmission operations in the OFDM-based wireless communications system.

15-25. (canceled)

26. A communications device as in claim 12 wherein the scheduler is configured to receive channel quality information associated with each of the communication resource units.

27. A apparatus as in claim 26 wherein to divide the communication resource units into a first group of communication resource units and a second group of communication resource units further comprises: to rank the communication resource units in terms of channel quality using the channel quality information; to select communication resource units having better channel quality and to assign them to the first group of communication resource units; and to assign communication resource units not assigned to the first group of communication resource units to the second group of communication resource units, the second group of communication resource units having worse channel quality.

28. A apparatus as in claim 27 wherein the scheduler is further configured to divide a plurality of communication devices operative in the communication system into the first group of communication devices and the second group of communication devices in dependence on which communication devices have requested information retransmission, where communication devices that have not requested information retransmission are assigned to the first group of communication devices and communication devices that have requested information retransmission are assigned to the second group of communication devices.

29. An apparatus as in claim 28 wherein the first group of communication resource units having better channel quality are used to transmit information to the first group of communication devices and the second group of communication resource units having worse channel quality are used to retransmit information to the second group of communication devices.

30. A computer program product comprising a computer readable memory medium tangibly embodying a computer program, the computer program configured to be executed by processing apparatus of a transmitting communication device operating in a wireless communication system, wherein when executed the computer program is configured to cause the transmitting communication device to divide a communication resource in use in a communication system into a plurality of communication resource units; to divide the communication resource units into a first group of communication resource units and a second group of communication resource units; to use the first group of communication resource units to transmit information to a first group of communication devices operative in the communication system; and to use the second group of communication resource units to retransmit information to a second group of communication devices operative in the communication system.

31. (canceled)

32. A computer program product as in claim 30 wherein the communication resource units comprise physical resource blocks available to perform information transmission and retransmission operations in the OFDM-based wireless communications system.

33-36. (canceled)

37. A computer program product as in claim 30 wherein when executed the computer program is further configured to cause the transmitting communications device to receive channel quality information associated with each of the communication resource units.

38. A computer program product as in claim 37 wherein when executed the computer program is further configured to cause the transmitting communication device to rank the communication resource units in terms of channel quality using the channel quality information; to select communication resource units having better channel quality and to assign them to the first group of communication resource units; and to assign communication resource units not assigned to the first group of communication resource units to the second group of communication resource units, the second group of communication resource units having worse channel quality.

39. A computer program product as in claim 38 wherein when executed the computer program is further configured to cause the transmitting communications device to divide a plurality of communication devices operative in the communications system into a first group of communication devices and the second group of communication devices in dependence on which communication devices have requested information retransmission, where communication devices that have not requested information retransmission are assigned to the first group of communication devices and the communication devices that have requested information retransmission are assigned to the second group of communication devices.

40. A computer program product as in claim 39 wherein the first group of communication resource units having better channel quality are used to transmit information to the first group of communication devices and the second group of communication resource units having worse channel quality are used to retransmit information to the second group of communication devices.

41-42. (canceled)
